(19) United States
(12) Patent Application Publication
(10) Pub. No.: US 2010/0135045 A1
(43) Pub. Date: Jun. 3, 2010

(54) Sine Wave Inverter

(76) Inventor: Hitoshi Inoue, (US)

Correspondence Address: Law Office of Scott C Harris Inc, PO Box 1389, Rancho Santa Fe, CA, 92067, US

(21) Appl. No.: 12/577,834

(22) Filed: Oct. 13, 2009

Related U.S. Application Data
(60) Provisional application No. 61/196,104, filed on Oct. 15, 2008.

(51) Int. Cl. H02M 3/335

(52) U.S. Cl. 363/17

(57) ABSTRACT

An inverter circuit having a single conversion stage with substantially zero-current switching.

The present application claims priority from Provisional application No. 61/196,104, filed Oct. 15, 2008, the entire contents of which are herewith incorporated by reference.

### FIELD OF THE SUBJECT MATTER

The present field of the subject matter relates to a method and apparatus for inverting DC power to AC power and vice-versa.

### BACKGROUND OF THE SUBJECT MATTER

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

Most DC-AC inverter results are achieved in two power conversion stages. The first converter stage has two purposes: First is to control output power in reference to AC power source from DC power source and a load current delivery to AC grid; and Second is isolation from DC power source to AC grid. The second conversion stage is to generate AC sine wave with PWM (Pulse Width Modulator) control.

This typical configuration leads to higher component counts and complications as well as reduced power conversion efficiency. In addition, most of these power conversion stages utilize the PWM control, which could cause high switching losses at both pulse rising and falling edges (Refer to U.S. Pat. Nos. 5,625,539; 6,281,485; 6,369,462; and 7,324,361).

### SUMMARY

According to embodiments, only one conversion stage with zero-current switching. The inventors believe that one challenge to improve conversion efficiency is to switch a high current (over hundred amps) with a high voltage (over several hundred volts) at zero current, or zero-voltage. If one of them is achieved, the only loss remaining is a conduction loss and this is typically immaterial for today's high frequency power switching devices.

Embodiments use a combination of zero-current switching and PWM control. When both the switching current and the frequency are high, the primary switching is made with the zero-current. When the switching current and frequency become sufficiently lower, which means the modulated sine wave approaches zero current/zero voltage regions, the control is shifted to PWM control.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 is a diagram depicting the sine wave inverter in accordance with an embodiment of the present subject matter.

FIG. 2 is a diagram depicting the sine wave inverter in accordance with an embodiment of the present subject matter.

FIG. 3 is a diagram depicting the sine wave inverter in accordance with an embodiment of the present subject matter.

FIG. 4 depicts the voltage waveforms of the first resonance stage of the sine wave inverter in accordance with an embodiment of the present subject matter.

FIG. 5 is a diagram depicting the sine wave inverter in accordance with an embodiment of the present subject matter.

FIG. 6 is a diagram depicting the sine wave inverter in accordance with an embodiment of the present subject matter.

FIG. 7 is a diagram depicting the sine wave inverter in accordance with an embodiment of the present subject matter.

FIG. 8 is a diagram depicting the sine wave inverter in accordance with an embodiment of the present subject matter.

FIG. 9 is a block diagram depicting the sine wave inverter in accordance with an embodiment of the present subject matter.

FIG. 10 depicts the primary current waveform of the transformer of the sine wave inverter in accordance with an embodiment of the present subject matter.

FIG. 11 depicts the output voltage compared to the primary switching current for the sine wave inverter in accordance with an embodiment of the present subject matter.

FIG. 12 is a diagram depicting the sine wave inverter in accordance with an embodiment of the present subject matter.

FIG. 13 is a diagram depicting the sine wave inverter without a transformer in accordance with an embodiment of the present subject matter.

### DESCRIPTION OF THE SUBJECT MATTER

All references cited herein are incorporated by reference in their entirety as though fully set forth. Unless defined otherwise, technical and scientific terms used herein have the same meaning as commonly understood by one of ordinary skill in the art to which the subject matter belongs.

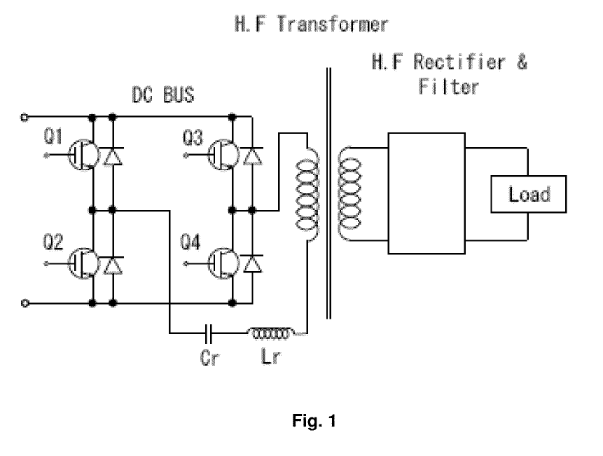

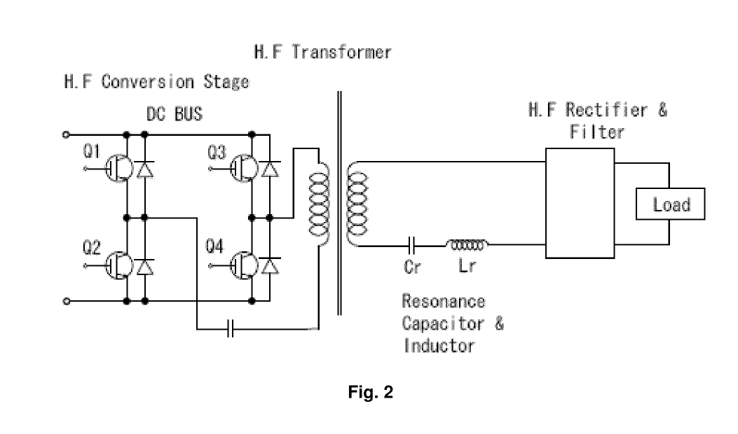

Typical series resonance circuits can be achieved as shown in FIG. 1. In this model, the resonance components are leakage inductance of the transformer Lr, and the series capacitance of Cr. This resonance circuit can be moved to secondary side as shown in FIG. 2. These are well known series resonance, or zero-current switching circuit. The problem occurs when these circuits are used to generate a sine wave and connected to an AC grid. Since these circuits work as a current source, when the control frequency is moved to lower side to decrease an output power, the primary switching current tends to increase to compensate the lowered switching frequency. As a result, the average output power stays the same even the switching frequency is lowered. This means the sine wave modulation does not work properly.

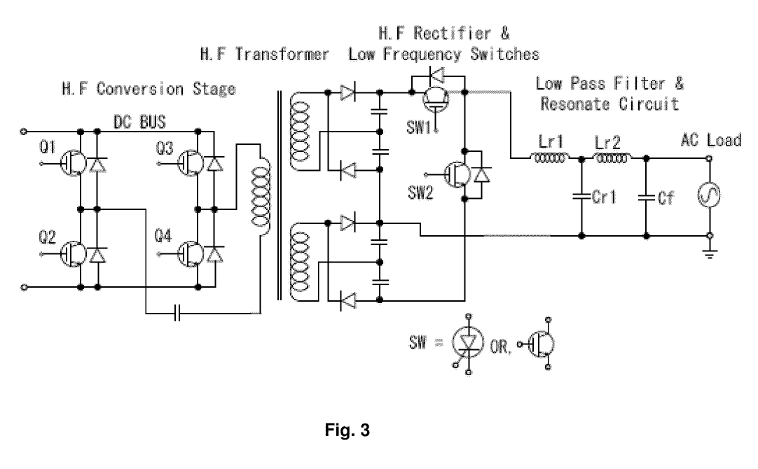

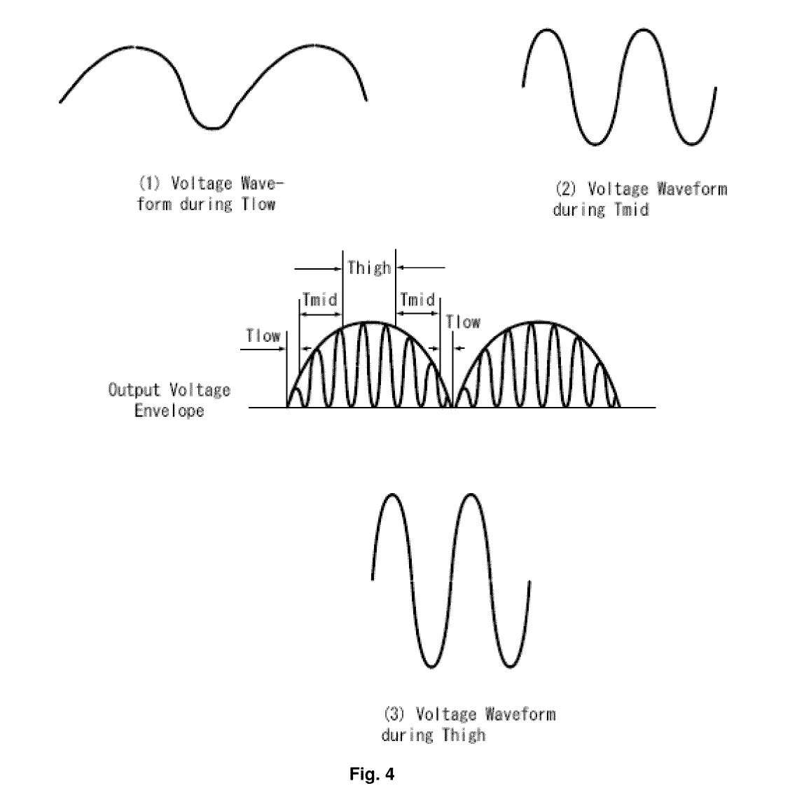

The present subject matter use two resonant, or low pass filter stages as shown in FIG. 3. First one forms a resonance network together with Lr1, Cr1, Lr2, where Cr1 is the first stage resonance capacitor, Lr1 is the first stage resonance inductance, Lr2 is second stage resonance inductance, and Cf is the filtering capacitor. The second stage works as a buffer for the first stage and also works as an AC low pass filter. This second stage buffer prevents the primary current from increasing when the switching frequency is lowered. However, the Lr2 inductance in the second stage is not only the impedance buffer but also works as a resonant component together with Lr1, and Cr1. Accordingly, the values of Lr1, Cr1, and Lr2 should be determined carefully to attain the best characteristics for the desirable result. At the same time, Cf and Lr2 form an AC low pass filter so that the high frequency switching current is filtered through. With the carefully chosen Lr1, Cr1, and Lr2, this two stage resonance circuit makes it possible for zero-current switching from almost zero power to 100% power keeping the high conversion efficiency. FIG. 4 shows the voltage waveforms of the first resonance stage. The output voltage envelop contains the modulated sine wave, which is generated by this resonance circuit.

To generate a sine wave, a programmed logic is used to modulate both frequency and pulse width at the same time according to a characteristic curve that is unique for each resonance circuit.

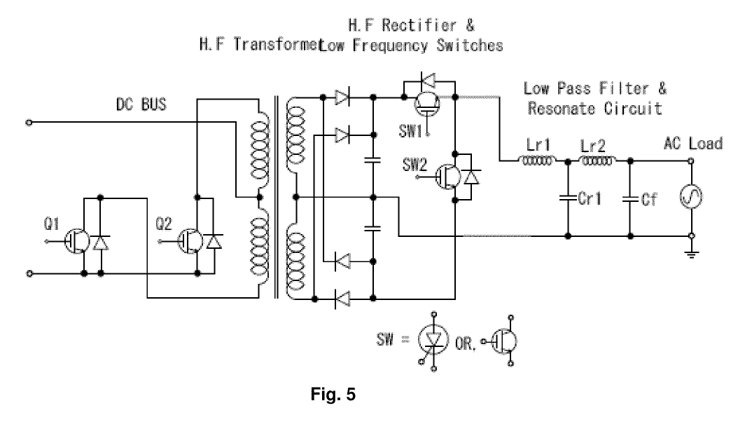

With the present subject matter, a minimal number of components are required, including: Two primary switching devices, one transformer with two secondary winding, two output rectifiers, two low frequency switches, one each resonating and filter circuits (FIG. 5).

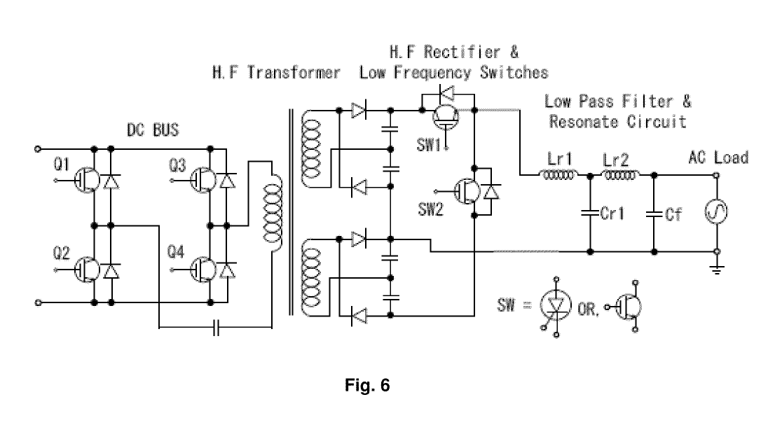

For a high output configuration, four switching devices (bridge configuration), one transformer with two secondary windings, two output rectifiers, two low frequency switches, one each resonating and filter circuits, are necessary (FIG. 6).

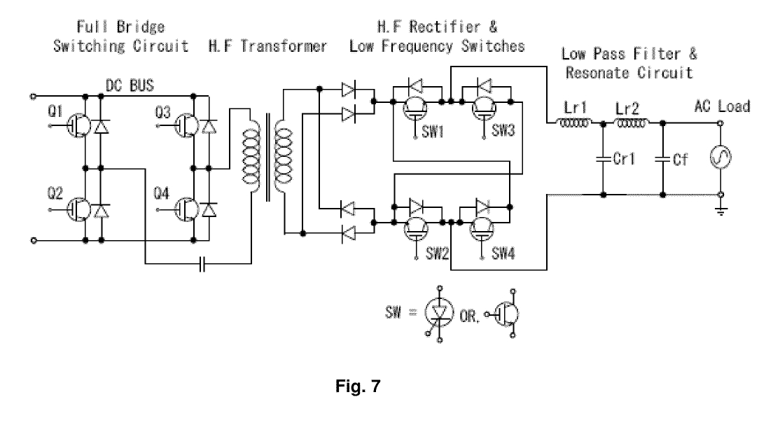

Alternatively, for a high output configuration, the following configuration may be incorporated: Four switching devices (bridge configuration), one transformer with one secondary winding, four output rectifiers, four low frequency switches, one each resonating and filter circuits (FIG. 7).

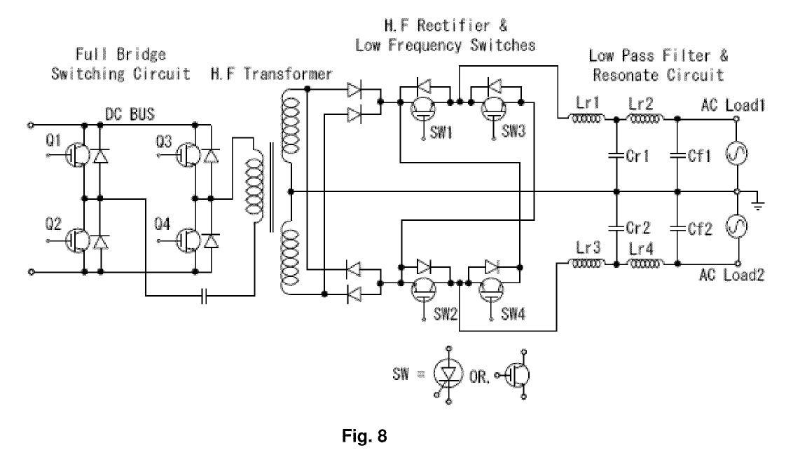

Another alternative for a high output configuration may consist of: Four switching devices (bridge configuration), one transformer with two secondary windings, four output rectifiers, four low frequency switches, two each resonating and filter circuits, for two loads with 3 wires system (FIG. 8).

Higher conversion efficiency is achieved and the number of components are reduced because of the single power conversion stage. Additionally, large amount of the heating loss is reduced because of zero-current switching.

One skilled in the art will recognize many methods and materials similar or equivalent to those described herein, which could be used in the practice of the present subject matter. Indeed, the present subject matter is in no way limited to the methods and materials described. For purposes of the present subject matter, the following terms are defined below.

The present subject matter uses frequency-pulse width modulation, in which both a switching frequency and the pulse width are modulated at the same time to make a zero-cross current switching for the majority of the output power range. To realize this function, there are 2 stage resonance/AC filter circuits formed at the secondary side of a transformer.

Output current is rectified with synchronization of the applied sine wave input (reference signal) to make a bidirectional sine wave output. The output rectifier, leakage inductance of a transformer, output inductors and capacitors form a resonating circuit so that the primary switching current can be switched at zero current both at current rising and falling edges. This zero current switching occurs during the majority of output power regions (typically from 10-20% to 100% power range). The remaining part of the output power is controlled with Pulse Width Modulation (“PWM”) control.

With the present subject matter, only one power conversion stage performs: 1) Isolation between DC power source and AC grids; 2) DC to sine wave generation with zero-current switching; 3) AC output control reference to feedback signals from AC output voltage/current; and 4) DC input voltage from DC power source.

With the present subject matter, the resonance circuit has two resonance components connected in series. This makes it possible for zero-current switching from low power to 100% power keeping the high conversion efficiency. To generate a sine wave, a programmed logic is used to modulate both frequency and pulse width at the same time according to a characteristic curve that is unique for each resonance circuit. This resonance circuit works as AC low pass filter for 50/60 Hz as well, and this contributes to less components count, less weight, and small size.

When high power conversion efficiency (typically more than 95%, or over) is required, zero-current or zero-voltage switching is essential. Because as a switching frequency is increased, the majority of power losses shift to the switching loss (pulse turns on and turns off switching losses) instead of a conduction loss of the switching device. This is more critical when the output power is increased. At 7 KW output, for example, a mere 10% power loss becomes 700 W, and it is not easy for cooling fans to cool down this much power, especially when the ambient temperature allowed is set at 50 C, for example. In addition, when small size, and light weight are required, one conversion stage is highly favored to the traditional two stage conversion scheme.

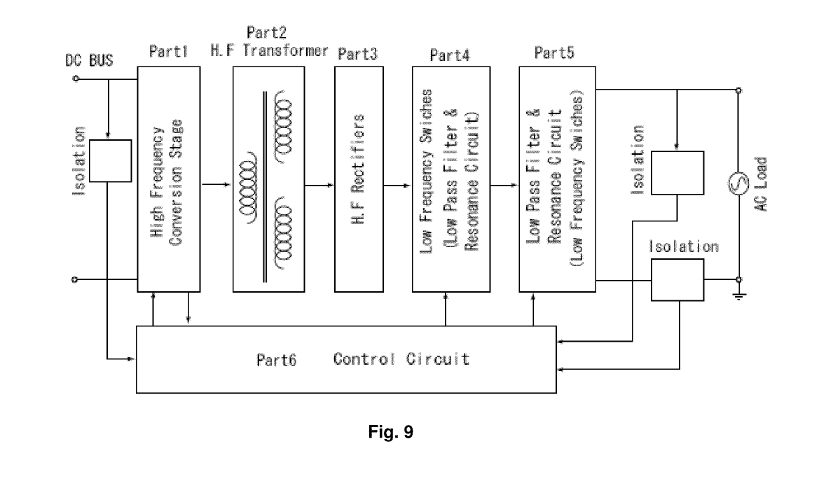

With reference to FIG. 9, a block diagram depicts one embodiment of the present subject matter. Part one is a H.F full-bridge conversion stage switched at zero-current. The switching frequency and pulse width are modulated at the same time according to input signal and reference signal to perform a zero-current switching. Part two is a high frequency power transformer. Part three is a high frequency full-wave rectifier. Part four is a two stage resonating circuit (made of Lr1, Cr1, Lr2, and Cf) and also works as a filter circuit for low frequency of 50/60 Hz. Part five are low frequency switches. In an alternative embodiment, Part five and Part four are interchanged.

For low frequency switches, any low speed but low conduction loss switching devices, such as Silicon Controlled Rectifier (“SCR”), or Insulated Gate Bipolar Transistor (“IGBT”) can be used.

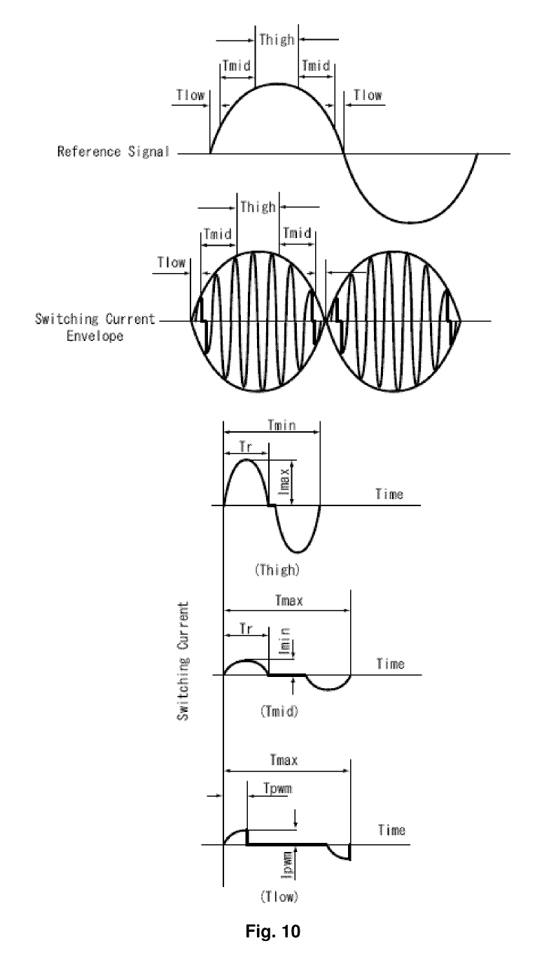

FIG. 10 shows the primary current waveform of the transformer (or, switching current). Notice that according to a low frequency reference signal (50/60 Hz), the peak switching current, switching frequency and pulse width are all changed.

At the peak part of sine-wave of the reference signal (Thigh), the switching frequency is the maximum of Fmax (=1/Tmin) with the pulse period of Tmin. Primary switching current becomes the maximum at this point since the switching frequency is matched to the resonance frequency of the secondary resonating circuit (decided by Cr & Lr). Turn on and turn off occurs at zero-current (zero-current switching).

At the middle part of waveform of the reference signal (Tmid), the switching frequency is lowered to Fmin=(1/Tmax) but the pulse period is kept the same of Tr. The peak switching current is significantly reduced since the switching frequency and the resonance frequency is not matched any more. The magnitude of the reduced current (Im) is related to a Q factor of the Lr, Cr resonating circuit. When Q value is high, the slightest frequency movement makes a significant current reduction. The current is still switched at zero-current (FIG. 4). When the switching frequency moves to Fmin (=1/Tmax), the switching current is a discontinued waveform, but the output voltage applied to the resonance circuit is a lower frequency but a continuous sine wave.

At the lowest part of Tlow of the reference signal, the switching frequency is kept the same of Fmin=1/Tmax but the pulse width is narrowed. At this point the primary switching can no longer keep the zero-current switching, and the current is controlled with PWM. Pulse width of Tpwm is controlled from Tr to zero. Since the peak current is substantially reduced at this region, the loss of PWM switching is negligible. Typically, the region of the PWM control stays in less than 10% of the maximum output power.

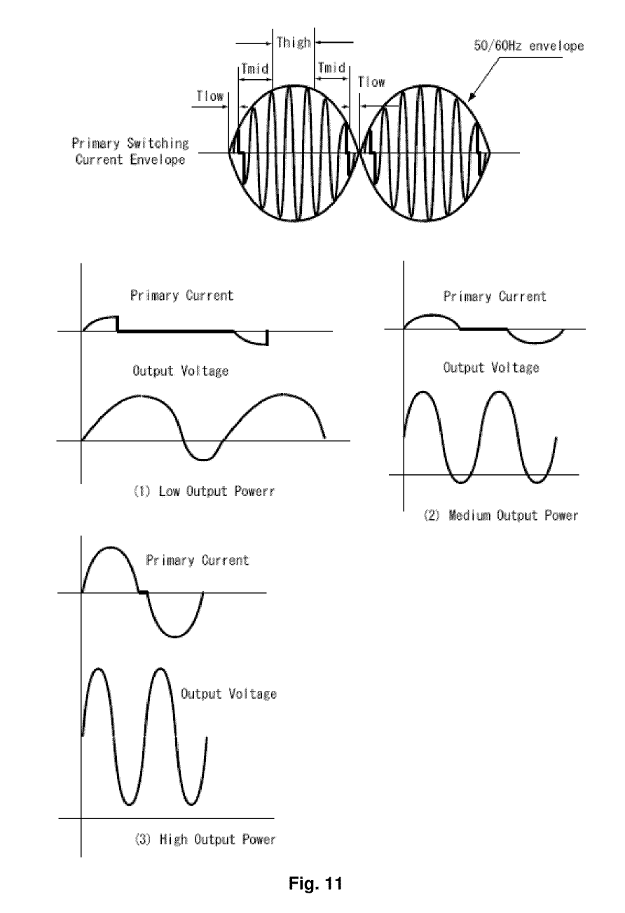

FIG. 11 shows the output voltage vs. primary switching current. As shown here, the output voltage is a sine wave even when the primary current is a discontinued or disturbed sine wave. The output voltage swings greater as the primary current increases. After the AC low pass filter, the envelope of this output voltage becomes an AC 50/60 Hz voltage as seen in FIG. 4.

Part four & Part five make a bi-directional AC sine wave. As mentioned previously, Part 4 and Part 5 may be interchanged, depending on configuration. For example, in FIG. 7, the switches and AC filter can be reversed.

As explained before, most zero-current or zero-voltage switching circuits are able to work in certain power ranges which are typically acceptable for most SMPS applications where power output is not modulated, and efficiency only matters at the maximum power region. Typically, prior art SMPS switching efficiency decreases dramatically when operated at 10-50% of the rated power

In generating sine wave applications applicable in the present subject matter, the modulation depth is 0% to 100%, requiring that the conversion stage maintain high efficiency from 0% to 100% modulation power to achieve a high efficiency sine wave inverter.

FIGS. 5 through 8 show various embodiments of the present subject matter. FIG. 5 is a simple configuration for lower power conversion, where only two switching IGBTs are used. FIG. 6, FIG. 7, and FIG. 8 are additional embodiments of the subject matter configured for different variations of power conversion.

FIG. 8 shows the embodiment for two loads, single phase, 3 wire systems, in which only one transformer with two windings, four low frequency switches, and one each resonating/AC filter circuit are used.

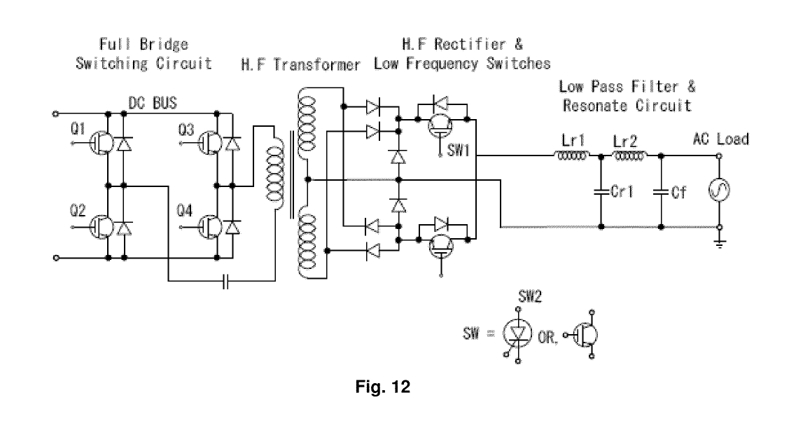

FIG. 12 shows another embodiment of center tap rectification for secondary circuit. With two additional H.F diodes, this circuit can reduce the spike voltage both for H.F diodes and low frequency switches.

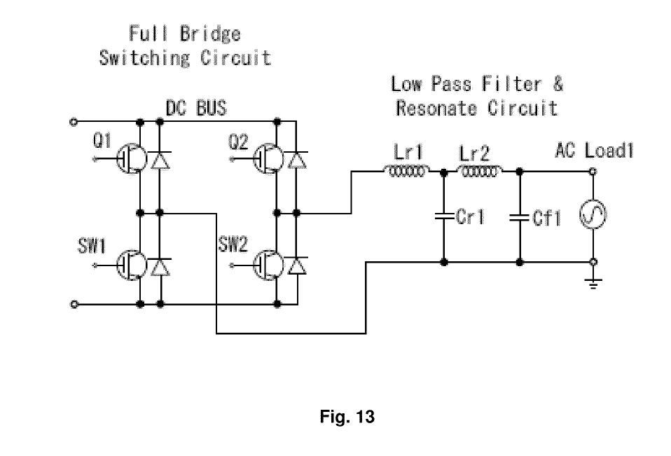

FIG. 13 shows the transformer-less embodiments. If DC input-output isolation is not required, the high frequency power transformer can be omitted. This scheme dramatically contributes to a small size and high conversion efficiency because there is no high frequency rectifiers and power transformer required. Even with these embodiments, the zero-current switching is functioned perfectly.

Experimental units of the present subject matter have achieved promising results typical of the claims stated above. Specifically, typical switching efficiency with the present subject matter has achieved between 95%-97% at 6.9 KW output power. Dimension for the subject matter are (including fans) 9.5″(W)×9″(D)×6.5″(H) with a weight of only 12 pounds. The units did not require any electrolytic capacitors. Since the electrolytic capacitors are the most critical components for elevated temperature, temperatures were maintained within acceptable levels.

The foregoing description of various embodiments of the subject matter known to the applicant at this time of filing the application has been presented and is intended for the purposes of illustration and description. The present description is not intended to be exhaustive nor limit the subject matter to the precise form disclosed and many modifications and variations are possible in the light of the above teachings. The embodiments described serve to explain the principles of the subject matter and its practical application and to enable others skilled in the art to utilize the subject matter in various embodiments and with various modifications as are suited to the particular use contemplated. Therefore, it is intended that the subject matter not be limited to the particular embodiments disclosed for carrying out the subject matter.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An inverter circuit having a single conversion stage with substantially zero-current switching.
